(19) United States
(12) Patent Application Publication
(10) Pub. No.: US 2025/0147633 A1
(43) Pub. Date: May 8, 2025

(54) Dual Capacitive Touch Confirmation

(71) Applicant: Panasonic Automotive Systems Company of America, Division of Panasonic Corporation of North America, PEACHTREE CITY, GA (US)

(72) Inventors: NICHOLAS BRIAN HANSEN, FAYETTEVILLE, GA (US); ANDREW PAUL REDWOOD, FAYETTEVILLE, GA (US)

(21) Appl. No.: 18/935,043

(22) Filed: Nov. 1, 2024

Related U.S. Application Data
(60) Provisional application No. 63/595,628, filed on Nov. 2, 2023.

(51) Int. Cl. G06F 3/044

(52) U.S. Cl. CPC G06F 3/0447

(57) ABSTRACT

A touch-sensitive screen arrangement includes a substrate configured to be touched by and elastically deformed or deflected by a finger of a human user. A first capacitive sensor is positioned relative to the substrate such that the first capacitive sensor can detect the substrate being touched by the finger. The first capacitive sensor is elastically deformed by the finger of the human user touching the substrate. A second capacitive sensor is positioned relative to the first capacitive sensor such that the second capacitive sensor can detect a change in capacitance between the first capacitive sensor, which is grounded to reduce the variability associated with the user, and the second capacitive sensor due to the elastic deformation of the first capacitive sensor that results from the substrate being touched by the finger.

### CROSS-REFERENCED TO RELATED APPLICATIONS

This application claims benefit of U.S. Provisional Application No. 63/595,628, filed on Nov. 2, 2023, the disclosure of which is hereby incorporated by reference in its entirety for all purposes.

### BACKGROUND OF THE INVENTION

### 1. Field of the Invention

The present invention relates to capacitive touch-sensitive screens.

### 2. Description of the Related Art

A problem with touch-sensitive screens which use capacitive touch sensing is the occurrence of “false touches” caused by incidental contact with an object that provides a similar increase in capacitance as the touch of a human finger. One classic example of a “false touch” comes from a charging cable being placed over the capacitive sensor of a touch-sensitive screen.

Classic “force sensing” systems utilize force sensors and other auxiliary circuitry to detect the force. These parts are high in cost, take up circuit board area and increase the complexity of the mechanical components required to activate the sensors.

### SUMMARY OF THE INVENTION

The invention may provide an augmentation of a classic capacitive touch sensing technology. The invention may combine a normal capacitive touch sensing array (referred to herein as “first sensor” or “first sensor array”) and a second sensor array. The capacitive touch sensing array may include one or more conductive pads situated substantially near and parallel to the surface presented to the user but not electrically exposed to the user. The second sensor array may be disposed near the capacitive touch sensing array and may be capacitively coupled to the capacitive touch sensing array. The second sensor array may not be electrically exposed to the capacitive touch sensing array and may be located on the opposite side of the capacitive touch sensing array from the user.

The user may indicate their desired selection by touching/contacting the area parallel to the capacitive touch sensing array. This contact results in an increase in capacitance between the capacitive touch sensing array and the user. The user can be thought of as the negative or ground terminal of the capacitor. An increase in capacitance at the capacitive touch sensing array results in a “potential touch”.

The system then switches to “confirmation mode” and grounds the entire first sensor array. This first sensor array plus the ground contribution of the user is then compared to the second sensor array in terms of capacitance.

The combination of the grounded first sensor array and the second sensor array can be thought of as a parallel plate capacitor with the first sensor array being the negative plate and the second sensor array being the positive terminal. If the first sensor array is being pushed closer to the second sensor array, as would be the case if a significant force is being applied to a plastic part supporting the first sensor array thus resulting in panel or spring element deflection, the capacitance between the two plates increases.

If the capacitance measured in “confirmation mode” exceeds a threshold established for either the detected button or for the entire sensor array, depending on the button configuration, then the “potential touch” becomes a “confirmed touch”.

The invention may provide a low-cost method of “force sensing” for implementation in some capacitive touch sensing situations. The inventive “force sensing” method may rule out a potential “false touch” by using a secondary sensor to detect a deflection that represents an elevated force applied at the touch site. Most causes of “false activation” do not provide such a force increase.

The invention does not require the additional components of known force sensing systems. Rather, the invention uses a single additional foil sensor that utilizes the same capacitive touch detection methods as the existing capacitive touch sensors and panel deflection. The existing capacitive touch sensors and panel deflection are actually a hinderance to most known “force sensing” systems.

A microcontroller can ground the second sensor array without any additional circuitry. Thus, the invention may provide a reduced cost and reduced complexity system that is less sensitive to part variation because the threshold capacitance values can be recalibrated using calibration algorithms over the life of the product.

The invention comprises, in one form thereof, a touch-sensitive screen arrangement includes a substrate configured to be touched by and elastically deformed or deflected by a finger of a human user. A first capacitive sensor is positioned relative to the substrate such that the first capacitive sensor can detect the substrate being touched by the finger. The first capacitive sensor is elastically deformed by the finger of the human user touching the substrate. A second capacitive sensor is positioned relative to the first capacitive sensor such that the second capacitive sensor can detect a change in capacitance between the first capacitive sensor and the second capacitive sensor due to the elastic deformation of the first capacitive sensor that results from the substrate being touched by the finger.

The second capacitive sensor is positioned relative to the first capacitive sensor to detect the change in capacitance between the first capacitive sensor and the second capacitive sensor while at least a portion of the first capacitive sensor is grounded. For example, at a minimum, a portion of the first capacitive sensor near the user's finger may be grounded. The system can function with only partial grounding of the sensor if it is divided into multiple segments.

The invention comprises, in another form thereof, a method of detecting a user touching a touch-sensitive screen. The method includes providing a substrate that is elastically deformed when touched by a finger of a human user. A first capacitive sensor is positioned relative to the substrate such that the first capacitive sensor detects the substrate being touched by the finger. The first capacitive sensor is elastically deformed by the finger of the human user touching the substrate. A second capacitive sensor is positioned relative to the first capacitive sensor such that the second capacitive sensor detects a change in capacitance between the first capacitive sensor and the second capacitive sensor due to the elastic deformation of the first capacitive sensor that results from the substrate being touched by the finger.

The invention comprises, in yet another form thereof, a method of detecting a user touching a touch-sensitive screen. The method includes providing a user-facing substrate on the touch-sensitive screen. A first voltage is applied to a first capacitive sensor. The substrate being touched by a finger of the user is detected by use of the first capacitive sensor while the first voltage is being applied to the first capacitive sensor. In response to the detecting step, the first capacitive sensor is electrically grounded and a second voltage is applied to a second capacitive sensor. The substrate being touched by the finger is detected by use of the second capacitive sensor while the first capacitive sensor is electrically grounded and while the second voltage is being applied to the second capacitive sensor.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic view of a one embodiment of a dual capacitive touch confirmation arrangement of the present invention.

FIG. 1A is a color version of FIG. 1.

FIG. 2 is a flow chart of operation of the arrangement of FIG. 1.

FIG. 3 is a schematic view of another embodiment of a dual capacitive touch confirmation arrangement of the present invention.

FIG. 4 is a flow chart of one embodiment of a method of the present invention for detecting a user touching a touch-sensitive screen.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

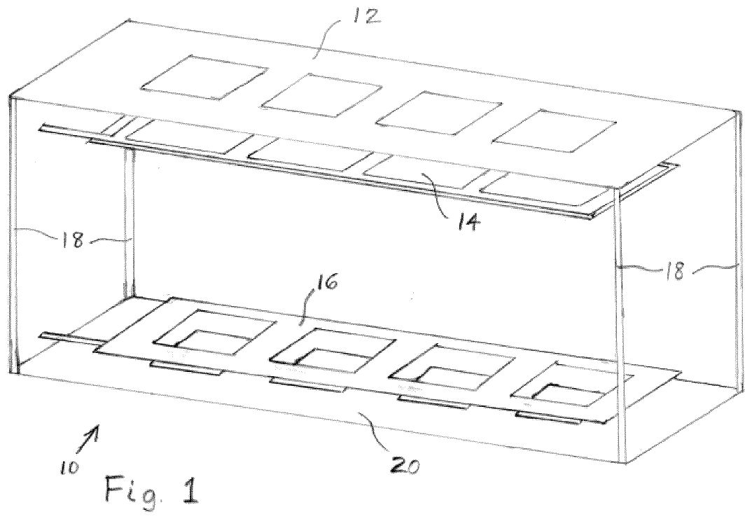

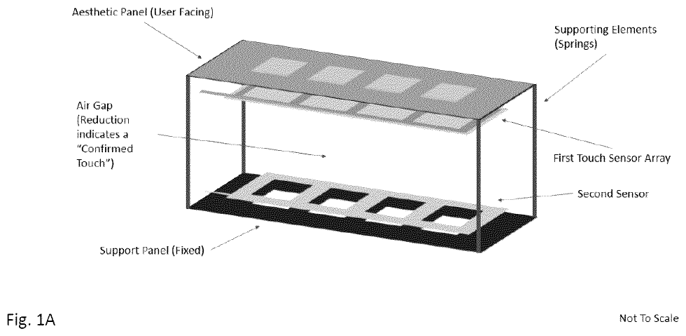

FIG. 1 illustrates (not to scale) one embodiment of a dual capacitive touch confirmation arrangement 10 of the present invention wherein capacitance is measured as a proxy for force. Arrangement 10 includes an aesthetic substrate or panel 12 that faces the user, a first touch sensor array 14, a second sensor 16, supporting elements (e.g., springs) 18, and a fixed support panel 20.

There is an air gap 22 between first touch sensor array 14 and a second sensor 16. A reduction in the height of air gap 22 occurs when a user touches panel 12 with this finger and thereby applies a force thereto. Thus, a reduction in the height of air gap 22 indicates a “confirmed touch”.

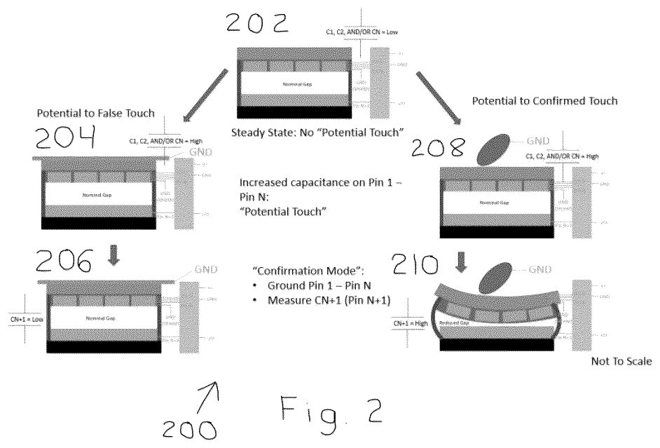

FIG. 2 illustrates (not to scale) a method 200 of operation of the arrangement 10 of FIG. 1. In a first step 202, a schematic diagram of the arrangement in steady state (e.g., with no person or object touching arrangement 10) is shown. First sensor array 14 may be positively charged, and second sensor 16 may be floating with no charge. The capacitance between first sensor array 14 and aesthetic panel 12 is low.

In step 204, a charging cable has been laid on aesthetic panel 12. The charging cable is not heavy enough to push first sensor array 14 closer to second sensor 16, but the charging cable increases the capacitance between aesthetic panel 12 and first sensor array 14 to a relatively high value. This increase in capacitance may be considered a “potential touch”.

Next, in step 206, arrangement 10 enters a confirmation mode in which pins 1 through N are grounded, thereby grounding both aesthetic panel 12 and first sensor array 14. Because first sensor array 14 is not deformed or deflected closer to second sensor 16 by the charging cable, there is no increase in capacitance between first sensor array 14 and second sensor 16 as a result of the charging cable being laid on aesthetic panel 12. The lack of increase in capacitance between first sensor array 14 and second sensor 16 indicates that aesthetic panel 12 is not being touched by a human finger, and thus it is not confirmed that aesthetic panel 12 is being touched.

Conversely, in step 208 aesthetic panel 12 is being touched by a human finger. First sensor array 14 is grounded, and second sensor 16 has a positive charge. The finger increases the capacitance between aesthetic panel 12 and first sensor array 14 to a relatively high value. This increase in capacitance may be considered a “potential touch”.

Next, in step 210, arrangement 10 enters a confirmation mode in which pins 1 through N are grounded, thereby grounding both aesthetic panel 12 and first sensor array 14. The human user may have learned via feedback from the system how much force he must manually exert on aesthetic panel 12 in order for his finger press to be recognized as a confirmed touch. First sensor array 14 could deflect, e.g., translate in space without deforming. Because first sensor array 14 is deflected or deformed closer to second sensor 16 by the user's finger, there is an increase in capacitance between first sensor array 14 and second sensor 16 as a result of the user's finger being pressed on aesthetic panel 12. The increase in capacitance between first sensor array 14 and second sensor 16 indicates that aesthetic panel 12 is being touched by a human finger, and thus it is confirmed that aesthetic panel 12 is being touched.

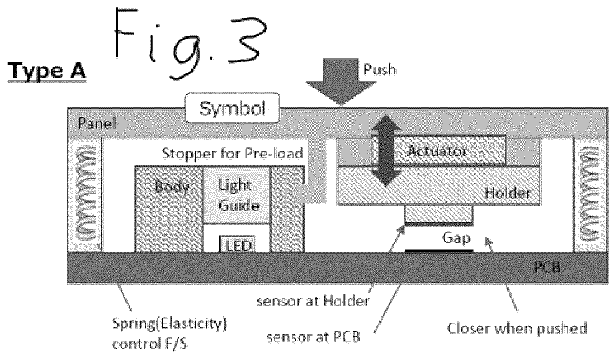

FIG. 3 illustrates another embodiment of a dual capacitive touch confirmation arrangement of the present invention. There is a speaker coil type actuator operating in the z-direction (e.g., from the top of the page of FIG. 3 to the bottom of the page, or vice versa) and attached to the panel.

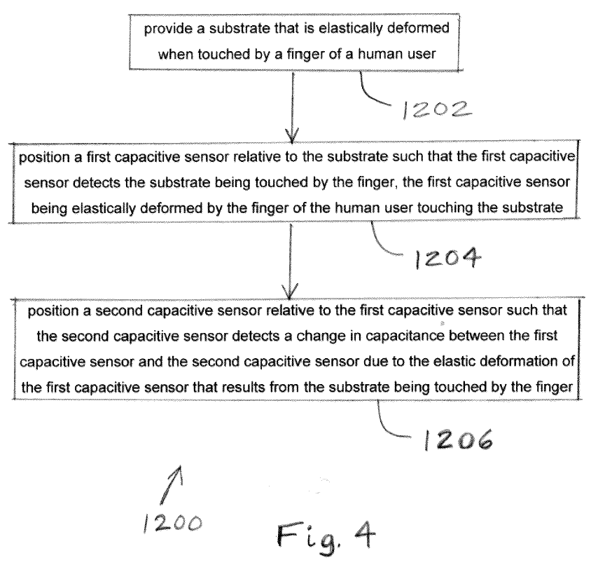

FIG. 4 illustrates one embodiment of a method 1200 of the present invention for detecting a user touching a touch-sensitive screen. In a first step 1202, a substrate that is elastically deformed when touched by a finger of a human user is provided. For example, aesthetic substrate or panel 12 may be provided.

In a next step 1204, a first capacitive sensor is positioned relative to the substrate such that the first capacitive sensor detects the substrate being touched by the finger. The first capacitive sensor is elastically deformed by the finger of the human user touching the substrate. For example, first touch sensor array 14 detects panel 12 being touched by the finger. First touch sensor array 14 may be elastically deformed by the finger of the human user touching panel 12.

In a final step 1206, a second capacitive sensor is positioned relative to the first capacitive sensor such that the second capacitive sensor detects a change in capacitance between the first capacitive sensor and the second capacitive sensor due to the elastic deformation of the first capacitive sensor that results from the substrate being touched by the finger. For example, second sensor 16 detects a change in capacitance between first touch sensor array 14 and second sensor 16 due to the elastic deformation of first touch sensor array 14 that results from panel 12 being touched by the finger.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A touch-sensitive screen arrangement, comprising:
a substrate configured to be touched by and elastically deformed or deflected by a finger of a human user;
a first capacitive sensor positioned relative to the substrate such that the first capacitive sensor can detect the substrate being touched by the finger, the first capacitive sensor being configured to be elastically deformed by the finger of the human user touching the substrate; and
a second capacitive sensor positioned relative to the first capacitive sensor such that the second capacitive sensor can detect a change in capacitance between the first capacitive sensor and the second capacitive sensor due to the elastic deformation of the first capacitive sensor that results from the substrate being touched by the finger.

2. The arrangement of claim 1 wherein the second capacitive sensor is positioned relative to the first capacitive sensor to detect the change in capacitance between the first capacitive sensor and the second capacitive sensor while at least a portion of the first capacitive sensor is grounded.

3. The arrangement of claim 2 wherein the first capacitive sensor is positioned relative to the substrate to detect the change in capacitance associated with the first capacitive sensor while the first capacitive sensor has a voltage applied thereto.

4. The arrangement of claim 1 wherein the elastic deformation of the first capacitive sensor results in the first capacitive sensor being moved closer to the second capacitive sensor.

5. The arrangement of claim 1 further comprising:
a fixed support panel supporting the second capacitive sensor; and
one or more springs interconnecting the substrate and the fixed support panel.

6. The arrangement of claim 5 wherein the second capacitive sensor can detect a change in capacitance between the first capacitive sensor and the second capacitive sensor due to an elastic deformation of at least one of the springs.

7. The arrangement of claim 1 wherein the first capacitive sensor includes a plurality of electrically conductive pads.

8. A method of detecting a user touching a touch-sensitive screen, the method comprising:
providing a substrate that is elastically deformed or deflected when touched by a finger of a human user;
positioning a first capacitive sensor relative to the substrate such that the first capacitive sensor detects the substrate being touched by the finger, the first capacitive sensor being elastically deformed by the finger of the human user touching the substrate; and
positioning a second capacitive sensor relative to the first capacitive sensor such that the second capacitive sensor detects a change in capacitance between the first capacitive sensor and the second capacitive sensor due to the elastic deformation of the first capacitive sensor that results from the substrate being touched by the finger.

9. The method of claim 8 wherein the second capacitive sensor is positioned relative to the first capacitive sensor to detect the change in capacitance between the first capacitive sensor and the second capacitive sensor while the first capacitive sensor is grounded and the second capacitive sensor has a voltage applied thereto.

10. The method of claim 9 wherein the first capacitive sensor is positioned relative to the substrate to detect the change in capacitance associated with the first capacitive sensor while the second capacitive sensor has a voltage applied thereto.

11. The method of claim 8 wherein the elastic deformation of the first capacitive sensor results in the first capacitive sensor being moved closer to the second capacitive sensor.

12. The method of claim 8 further comprising:
providing a fixed support panel supporting the second capacitive sensor; and
providing one or more springs interconnecting the substrate and the fixed support panel.

13. The method of claim 12 further comprising using the second capacitive sensor to detect a change in capacitance between the first capacitive sensor and the second capacitive sensor due to an elastic deformation of at least one of the springs.

14. The method of claim 8 wherein the first capacitive sensor includes a plurality of electrically conductive pads.

15. A method of detecting a user touching a touch-sensitive screen, the method comprising:
providing a user-facing substrate on the touch-sensitive screen;
applying a first voltage to a first capacitive sensor;
detecting the substrate being touched by a finger of the user, the detecting being performed by use of the first capacitive sensor while the first voltage is being applied to the first capacitive sensor;
in response to the detecting step, electrically grounding the first capacitive sensor and applying a second voltage to a second capacitive sensor; and
detecting the substrate being touched by the finger, the detecting being performed by use of the second capacitive sensor while the first capacitive sensor is electrically grounded and while the second voltage is being applied to the second capacitive sensor.

16. The method of claim 15 wherein the second capacitive sensor detects the substrate being touched by the finger due to the finger pushing the first capacitive sensor closer to the second capacitive sensor.

17. The method of claim 16 wherein the first capacitive sensor is moved closer to the second capacitive sensor due to the substrate and first capacitive sensor being elastically deformed when the substrate is touched by the finger of the human user.

18. The method of claim 15 further comprising:
providing a fixed support panel supporting the second capacitive sensor; and
providing one or more springs interconnecting the substrate and the fixed support panel.

19. The method of claim 18 further comprising using the second capacitive sensor to detect a change in capacitance between the first capacitive sensor and the second capacitive sensor due to an elastic deformation of at least one of the springs.

20. The method of claim 15 wherein the first capacitive sensor includes a plurality of electrically conductive pads.
